(19) United States
(12) Patent Application Publication
(10) Pub. No.: US 2026/0283440 A1
(43) Pub. Date: Sep. 24, 2026

(54) MOP BUCKET PUMP WATER CLEANING MECHANISM AND WORKING METHOD THEREOF

(71) Applicant: Gaobeidian Restar Electrical Applicances Manufacture Co., Ltd, Baoding (CN)

(72) Inventor: Shaoliang Xu, Baoding (CN)

(21) Appl. No.: 19/291,879

(22) Filed: Aug. 6, 2025

(30) Foreign Application Priority Data
Mar. 21, 2025 (CN) 2025103371389

(51) Int. Cl. A47L 13/58; B08B 1/12; B08B 1/16; B08B 1/20; B08B 3/02; F04B 19/22; F16H 21/54

(52) U.S. Cl. CPC A47L 13/58; B08B 1/12; B08B 1/165; B08B 1/20; B08B 3/022; F04B 19/22; F16H 21/54

(57) ABSTRACT

A mop bucket pump water cleaning mechanism disposed in a cleaning opening of a mop bucket main body includes a cleaning opening bracket and water pumps. The cleaning opening bracket is configured to install limiting rollers and a cleaning assembly, the cleaning opening bracket is detachably installed below a top panel disposed at a top opening of the mop bucket main body, and the cleaning opening is defined on the top panel and the cleaning opening bracket. The limiting rollers are configured to limit a back of a mop plate inserted into the cleaning opening, and the cleaning assembly is configured to spray water to clean a cleaning pad on a front side of the mop plate. The water pumps are disposed in a clean water chamber of the mop bucket main body, and the water pumps are configured to pump water to the cleaning assembly.

### TECHNICAL FIELD

The disclosure relates to the technical field of cleaning tools, and particularly to a mop bucket pump water cleaning mechanism and a working method thereof.

### BACKGROUND

In the market, cleaning and wringing of flat mops mostly adopt a method of soaking a mop in clean water area for cleaning, and then setting up a wringer device with a scraper plate inside a bucket for wringing out water of the mop. While wringing and scraping, dirt on the mop head is removed, and dirty water flows back to the clean water area. This mop structure is simple, economical, and practical. However, the current flat mop on the market, when soaked and cleaned in the clean water area, cannot ensure thorough cleaning of the water. After multiple uses, the water turns into dirty water and cannot effectively clean the mop.

At present, many mop buckets with separated clean and dirty water have emerged, no longer using the soaking method for cleaning, but instead using a water-pumping and spraying method to clean a cleaning pad of a flat mop. The Chinese patent with the publication No. CN217610946U discloses a mop cleaning device with clean and dirty water drainage. A water supply mechanism pumps clean water from a storage chamber to spray and clean the mop. It can ensure that the clean water is used to clean a cleaning pad of a flat mop, and the dirty water is collected in a dirty water chamber. However, the water supply mechanism uses gears and racks to transmit power to a water pump. It requires additional arrangement of the gears and the racks, resulting in a relatively complex transmission structure that is prone to failure. The Chinese patent with the publication No. CN217987499U also has the same technical defect and cannot avoid the problem of a complex transmission mechanism that is prone to failure.

To overcome the above-mentioned problems, a mop bucket pump water cleaning mechanism and a working method thereof are needed.

### SUMMARY

The purpose of the disclosure is to provide a mop bucket pump water cleaning mechanism and a working method thereof, which directly utilizes original limiting rollers as a power source to drive water pumps for pumping water, thereby simplifying a structure and reducing failure rate.

To solve above problem, the technical solutions of the disclosure are as follows.

A mop bucket pump water cleaning mechanism is disposed in a cleaning opening of a mop bucket main body, and the mop bucket pump water cleaning mechanism includes a cleaning opening bracket and water pumps. The cleaning opening bracket is configured to install limiting rollers and a cleaning assembly, the cleaning opening bracket is detachably installed below a top panel at a top opening of the mop bucket main body, and the cleaning opening is defined on the top panel and the cleaning opening bracket. The limiting rollers are configured to limit a back of a mop plate inserted into the cleaning opening, and the cleaning assembly is configured to spray water to clean a cleaning pad on a front side of the mop plate. The water pumps are disposed in a clean water chamber of the mop bucket main body, the limiting rollers are configured to transmit power to the water pumps through transmission assemblies, respectively, and the water pumps are configured to pump water to the cleaning assembly.

In an embodiment, each of the transmission assemblies includes a connecting rod and a rocker arm, and a central axis of the rocker arm is coaxially fixedly connected to a central axis of a corresponding one of the limiting rollers. An eccentric shaft head of the rocker arm is rotatably connected to a top end of the connecting rod, and a bottom end of the connecting rod is connected to a piston of a corresponding one of the water pumps.

In an embodiment, an outlet pipe of each of the water pumps extends upward and is connected to a water-guiding channel of the top panel, and the water-guiding channel is configured to guide water to the cleaning assembly.

In an embodiment, the cleaning assembly includes a clean water cover plate, the top panel defines a clean water storage trough on an opposite side of the limiting rollers, an outlet end of the water-guiding channel is connected to the clean water storage trough, the clean water cover plate is sealed and covered on the clean water storage trough, and a front end of the clean water cover plate facing towards the cleaning opening defines multiple water outlets.

In an embodiment, the clean water cover plate is made of transparent plastic material.

In an embodiment, the cleaning assembly further includes a brush strip, the brush strip are disposed below the clean water storage trough, and bristles of the brush strip are configured to clean the cleaning pad of the mop plate.

In an embodiment, the cleaning assembly further includes an auxiliary scraper, the auxiliary scraper is disposed parallel to a lower part of the brush strips, and the auxiliary scraper is configured to perform partial dewatering on the cleaning pad of the mop plate.

In an embodiment, a number of the limiting rollers is two, the two limiting rollers are symmetrically disposed on two sides of the cleaning opening, and a number of the transmission assemblies and a number of the water pumps are two.

In an embodiment, the limiting rollers are rubber wheels, or an outer wheel surface of each of the limiting rollers is sleeved with a rubber gasket, and friction strips are disposed on contact positions between the back of the mop plate and the limiting rollers, respectively.

A working method of the mop bucket pump water cleaning mechanism mentioned above includes steps as follows. The mop bucket pump water cleaning mechanism is used to clean the cleaning pad of the mop plate, the limiting rollers on the cleaning opening are used as a power source to output the power to the water pumps, to thereby pumping the water to spray and clean the cleaning pad of the mop plate.

Compared to the related art, the beneficial effects of the disclosure are as follows.

The mop bucket pump water cleaning mechanism of the disclosure uses the limiting rollers as the driving power source for the water pumps, achieving secondary utilization of power while providing rolling limitation for the mop plate. Compared with the related art, this avoids the need for additional gear assemblies, simplifies the structure, and reduces the failure rate of the mop bucket.

In addition, coaxial and fixed connection of the central axis of each of the rocker arms with the central axis of each of the limiting rollers simplifies the transmission structure of the mop bucket, and the rotation of the central axis is directly converted into a reciprocating linear motion of the piston, improving kinetic energy efficiency. An eccentric shaft head is designed with a split half-shaft structure at its cantilever end, facilitating disassembly and installation of each of the connecting rods. The arrangement of the water-guiding channels and the clean water storage trough enables smooth water flow from the water pumps. The clean water cover plate seals the clean water storage trough and forms water outlets along its front edge to spray water onto the cleaning pad for rinsing. The clean water cover plate made of transparent plastic allows for visual observation of the water flow. The brush strip is configured to perform deep scraping and cleaning of the cleaning pad on the mop plate, removing embedded dirt and impurities. By adding an auxiliary scraper to a lower part of the brush strip, the auxiliary scraper is configured to perform partial dewatering (i.e., semi-dry dewatering) on the cleaning pad, removing dirty water and allowing the cleaning pad to reabsorb clean water during the next spray cycle, thereby improving cleaning efficiency. By providing two sets of the transmission assemblies and two sets of the water pumps, the water flow rate is increased to ensure sufficient cleaning water supply. Moreover, the mop plate receives even force on two sides of its back surface, preventing tilting and enabling smooth vertical reciprocating motion without scraping against the bucket wall. The limiting rollers are made of rubber wheels or an outer wheel surface of each of the limiting rollers is sleeved with a rubber gasket, increasing friction between the limiting rollers and the back of the mop plate to ensure smooth driving of the limiting rollers. By providing corresponding friction strips on the back of the mop plate, the friction with the limiting rollers is further increased, preventing slippage.

The working method of the mop bucket pump water cleaning mechanism of the disclosure adopts a friction wheel transmission method to provide driving force for the water pumps, eliminating the need for additional racks and gears. This simplifies the structure, avoids gear jamming failures, and shortens the transmission chain, thereby reducing resistance during cleaning.

### BRIEF DESCRIPTION OF DRAWINGS

The disclosure will be further explained in conjunction with the attached drawings.

FIG. 1 illustrates a schematic sectional structural diagram from a front perspective of a mop bucket installed with a mop bucket pump water cleaning mechanism in the disclosure.

FIG. 2 illustrates a schematic structural diagram from a top perspective of the mop bucket installed with the mop bucket pump water cleaning mechanism in the disclosure.

FIG. 3 illustrates a three-dimensional schematic structural diagram of the mop bucket pump water cleaning mechanism in the disclosure.

FIG. 4 illustrates a three-dimensional schematic structural diagram from another perspective of the mop bucket pump water cleaning mechanism in the disclosure.

FIG. 5 illustrates a schematic structural diagram from a front perspective of the mop bucket pump water cleaning mechanism in the disclosure.

FIG. 6 illustrates a three-dimensional schematic structural diagram of the mop bucket pump water cleaning mechanism with a top panel removed in the disclosure.

FIG. 7 illustrates a partially enlarged schematic structural diagram of a portion I illustrated in FIG. 6.

FIG. 8 illustrates a three-dimensional schematic structural diagram of a mop plate used in conjunction with the mop bucket pump water cleaning mechanism in the disclosure.

### Description of reference numerals

1. mop bucket main body; 101. clean water chamber; 102. dirty water chamber; 103. cleaning opening; 104. wringing opening; 2. cleaning opening bracket; 3. brush strip; 31. bristle; 4. top panel; 41. clean water storage trough; 401. water-guiding channel; 402. water inlet; 5. clean water cover plate; 501. water outlet; 6. limiting roller; 7. water pump; 71. piston; 701. outlet pipe; 8. connecting rod; 9. rocker arm; 901. eccentric shaft head; 10. mop plate; 1001. friction strip.

### DETAILED DESCRIPTION OF EMBODIMENTS

The following will further explain the structural and working principles of the disclosure in detail with reference to the attached drawings.

The core of the disclosure is to provide a mop bucket pump water cleaning mechanism and a working method thereof, which directly uses original limit roller as a power source to drive water pumps to pump water, simplifies the structure, and reduces the failure rate.

The technical solutions in the embodiments of the disclosure will be described clearly and completely below in conjunction with the attached drawings. Apparently, the described embodiments are only some of the embodiments of the disclosure, rather than all of them. Based on the embodiments of the disclosure, all other embodiments obtained by those skilled in the art without making creative efforts shall fall within the scope of protection of the disclosure.

In the description of the disclosure, it should be understood that the terms such as “upper,” “lower,” “front,” “rear,” “left,” “right,” “top,” “bottom,” “inner,” and “outer,” which indicate orientation or positional relationships, are based on the orientations or positions shown in the attached drawings. These terms are used solely to facilitate and simplify the description of the disclosure, rather than to indicate or imply that the devices or elements referred to must have a specific orientation, be constructed in a specific orientation, or be operated in a specific manner. Therefore, they should not be construed as limitations on the disclosure.

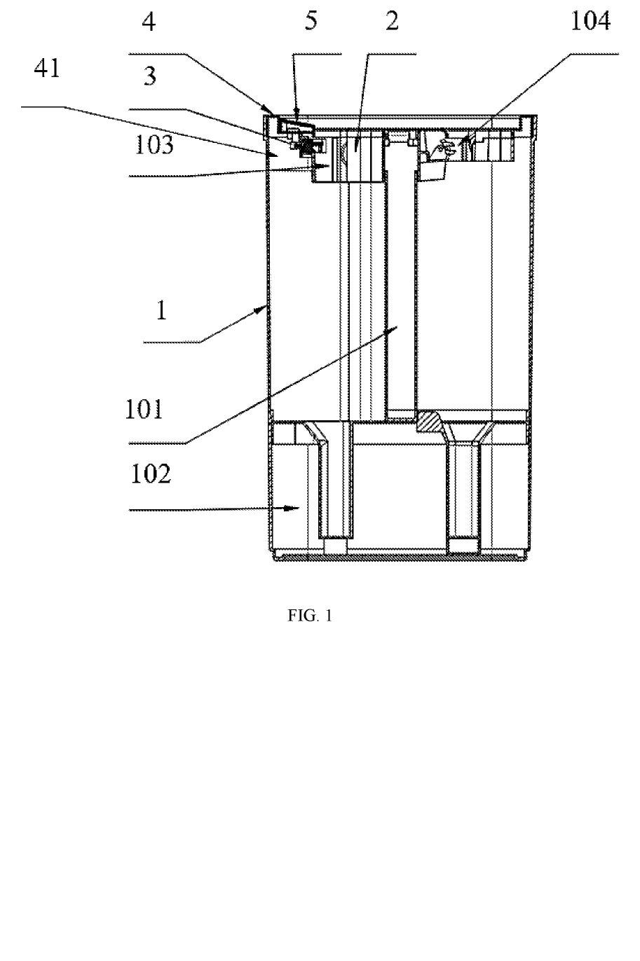

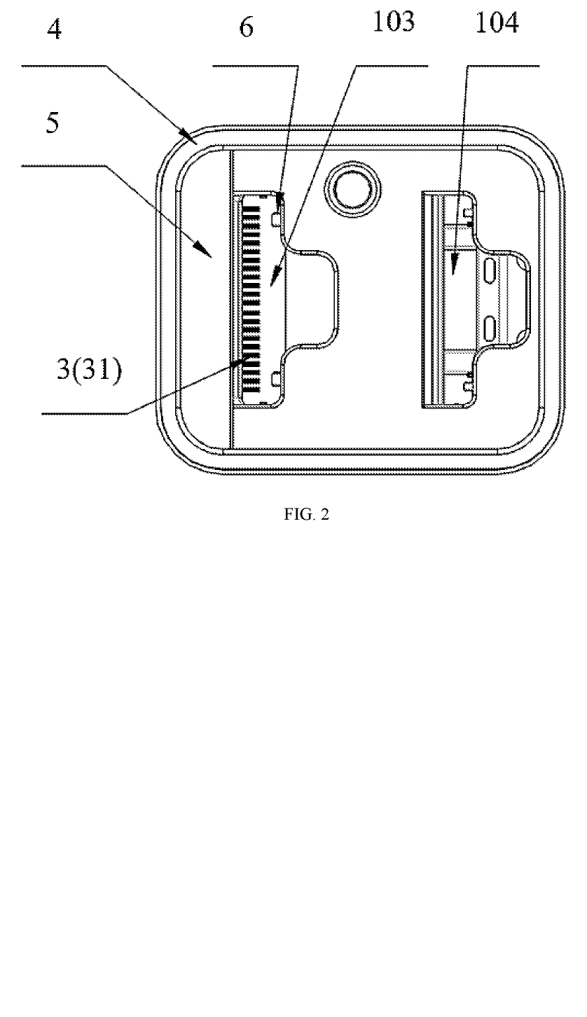

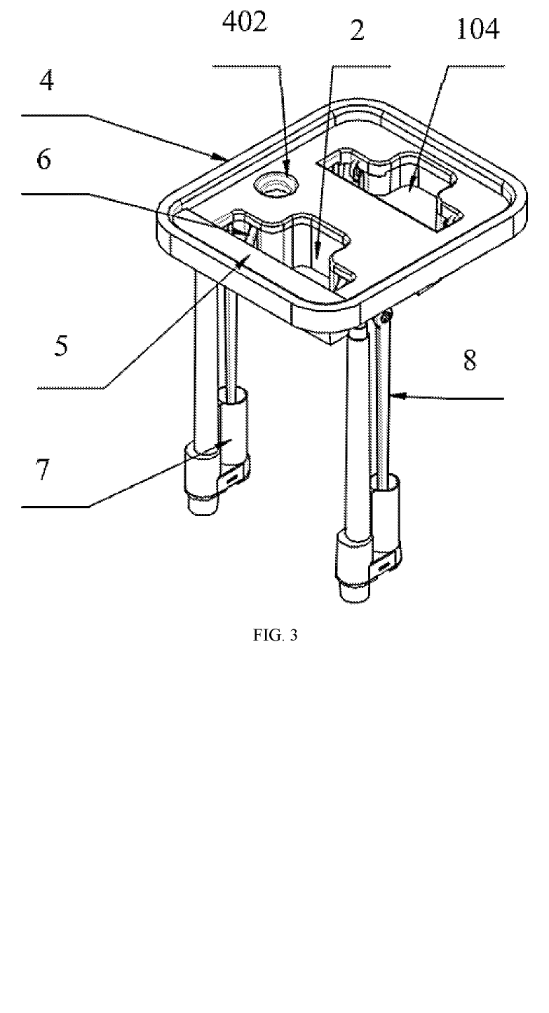

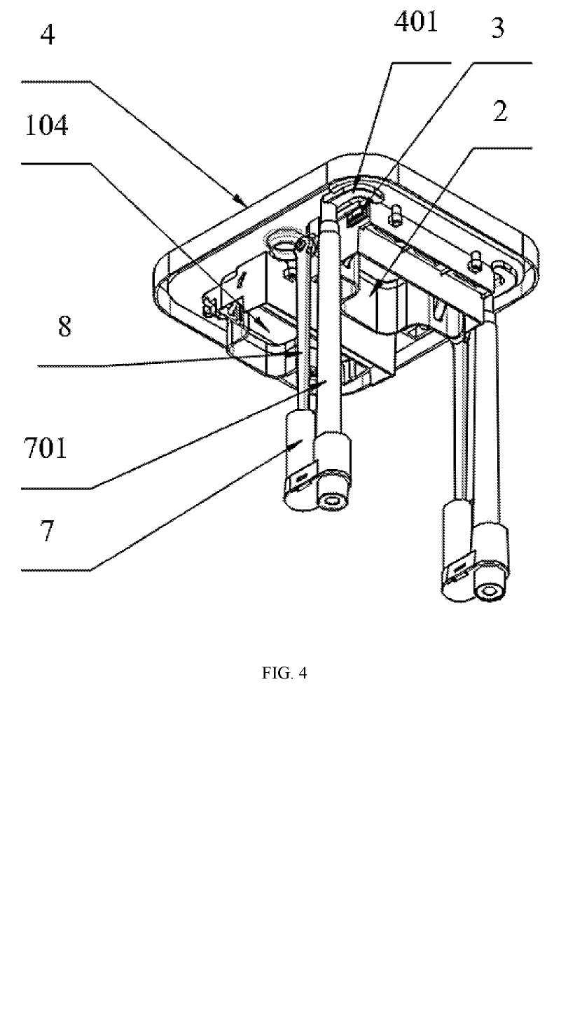

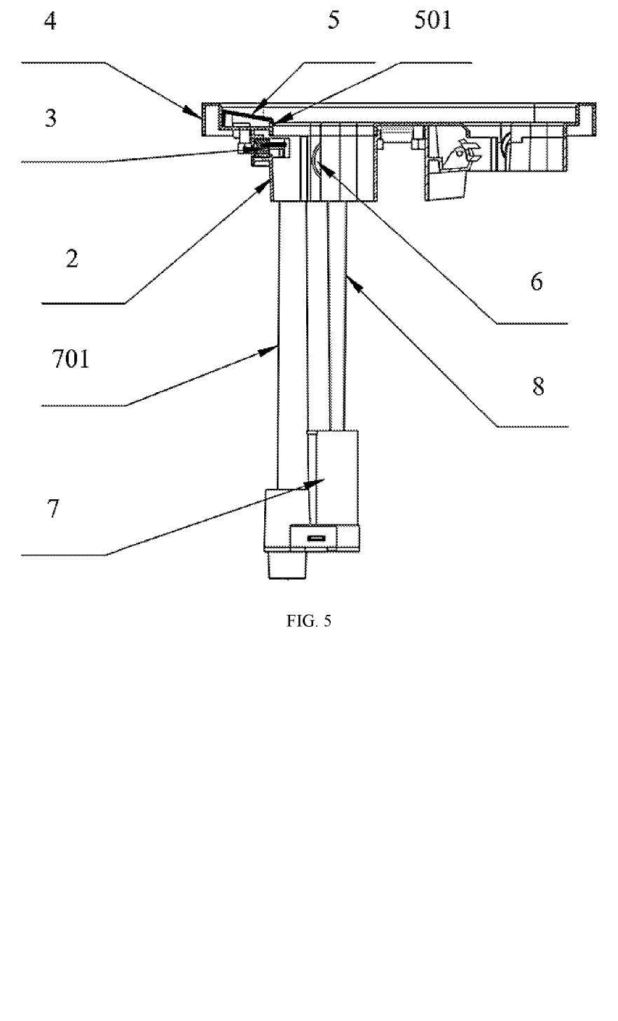

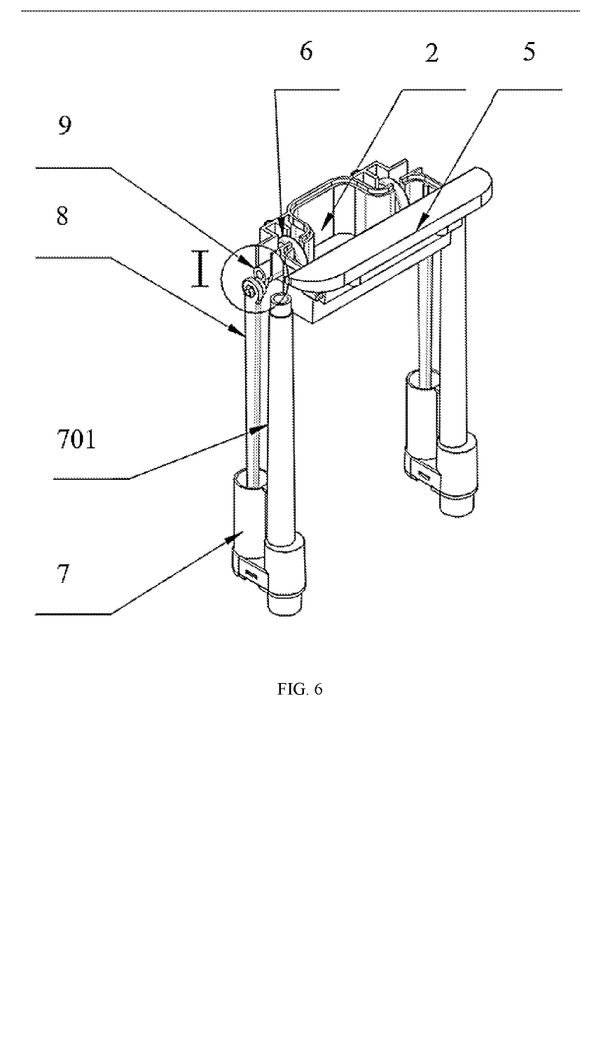

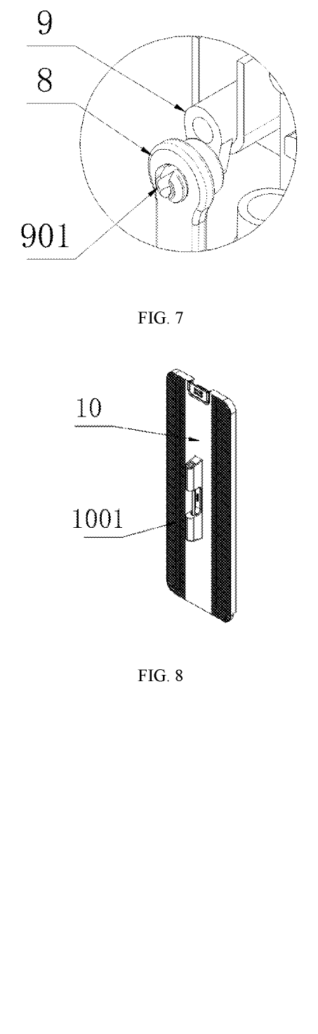

As shown in FIGS. 1-8, FIG. 1 illustrates a schematic sectional structural diagram from a front perspective of a mop bucket installed with a mop bucket pump water cleaning mechanism in the disclosure. FIG. 2 illustrates a schematic structural diagram from a top perspective of the mop bucket installed with the mop bucket pump water cleaning mechanism in the disclosure. FIG. 3 illustrates a three-dimensional schematic structural diagram of the mop bucket pump water cleaning mechanism in the disclosure. FIG. 4 illustrates a three-dimensional schematic structural diagram from another perspective of the mop bucket pump water cleaning mechanism in the disclosure. FIG. 5 illustrates a schematic structural diagram from a front perspective of the mop bucket pump water cleaning mechanism in the disclosure. FIG. 6 illustrates a three-dimensional schematic structural diagram of the mop bucket pump water cleaning mechanism with a top panel removed in the disclosure. FIG. 7 illustrates a partially enlarged schematic structural diagram of a portion I illustrated in FIG. 6. FIG. 8 illustrates a three-dimensional schematic structural diagram of a mop plate used in conjunction with the mop bucket pump water cleaning mechanism in the disclosure.

In an embodiment, as shown in FIGS. 1-7, a mop bucket pump water cleaning mechanism is disposed in a cleaning opening 103 of a mop bucket main body 1, and the mop bucket pump water cleaning mechanism includes a cleaning opening bracket 2 and water pumps 7. The cleaning opening bracket 2 is configured to install limiting rollers 6 and a cleaning assembly. The cleaning opening bracket 2 is detachably installed below a top panel 4 disposed at a top opening of the mop bucket main body 1, the cleaning opening 103 is defined on the top panel 4 and the cleaning opening bracket 2. The top panel 4 is fitted over a top opening of the bucket main body 1, and an end of the top panel 4 facing away from the cleaning opening 103 is formed with a wringing opening 104. The limiting rollers 6 are configured to limit a back of a mop plate 10 inserted into the cleaning opening 103, ensuring an appropriate distance between the cleaning pad on the front side of the mop plate 10 and the cleaning assembly. Generally, all mop buckets require limiting rollers or at least limiting protrusions on the cleaning opening 103 to abut against the back of the mop plate 10. The cleaning assembly is configured to spray water to clean the cleaning pad on the front side of the mop plate 10. The water pumps 7 are disposed in a clean water chamber 101 of the mop bucket main body 1. The limiting rollers 6 are configured to transmit power to the water pumps 7 through transmission assemblies, respectively, and the water pumps 7 are configured to pump water to the cleaning assembly.

By using the limiting rollers 6 as the driving power source for the water pumps 7, the mechanism achieves secondary utilization of power while providing rolling limitation for the mop plate 10. Compared with the related art, this avoids the need for additional gear assemblies, simplifies the structure, and reduces the failure rate of the tool.

The existing mop bucket molds can be easily modified to produce the clean and dirty water separation mop bucket of the disclosure. By utilizing the original limiting rollers and adding corresponding water pumps and transmission assemblies, the production cost of mold development is reduced.

In an embodiment, as shown in FIGS. 3-6, each of the transmission assembly includes a connecting rod 8 and a rocker arm 9. A central axis of the rocker arm 9 is coaxially and fixedly connected to a central axis of the limiting roller 6, and the connecting rod 8 and a corresponding rocker arm 9 may be integrally formed or directly welded together by heat fusion. The central axis of limiting roller 6 is horizontally mounted on the cleaning opening bracket 2 via a support seat, and lower support ribs of the top panel 4 limit the central axis of limiting roller 6 within the support seat. An eccentric shaft head 901 of the rocker arm 9 is rotatably connected to a top end of the connecting rod 8, and a bottom end of the connecting rod 8 is connected to a piston 71 of a corresponding one of the water pumps 7, thereby driving the piston 71 to perform a reciprocating linear motion to achieve the water pumping action.

Specifically, as shown in FIG. 7, a cantilever end of the eccentric shaft head 901 is designed in a form of a split half-shaft, with a clearance gap formed in a middle to facilitate smooth installation of shaft holes at the top end of the connecting rod 8.

By coaxially and fixedly connecting the central axis of the rocker arm 9 with that of the limiting roller 6, the transmission structure is simplified, and the rotation of the central axis is directly converted into the reciprocating linear motion of the piston 71, thereby improving kinetic energy efficiency. The split half-shaft design at the cantilever end of the eccentric shaft head 901 also facilitates the disassembly and installation of the connecting rod 8.

In an embodiment, as shown in FIGS. 4 and 5, an outlet pipe 701 of each of the water pumps 7 extends upward and is connected to a water-guiding channel 401 of the top panel 4, and the water-guiding channel 401 is configured to guide the water to the cleaning assembly.

Specifically, the clean water cover plate 5 is made of transparent plastic material.

Through an arrangement of the water-guiding channel 401 and the clean water storage trough 41, the water discharged from the water pumps 7 can be smoothly conveyed. The clean water cover plate 5 seals the clean water storage trough 41 and forms water outlet 501 along its front edge to spray water onto the cleaning pad for rinsing. The use of transparent plastic material for the clean water cover plate 5 allows for a clear visual observation of the water flow.

In an embodiment, as shown in FIGS. 1, 2 and 5, the cleaning assembly further includes a brush strip 3, the brush strip 3 is disposed below the clean water storage trough 41, and bristles 31 of the brush strip 3 are configured to clean the cleaning pad on the mop plate 10.

Specifically, the cleaning assembly further includes an auxiliary scraper 32, which is made of rigid plastic material. The auxiliary scraper 32 is disposed parallel to a lower part of the brush strip 3, and the auxiliary scraper 32 is configured to perform partial dewatering (i.e., semi-dry dewatering) on the cleaning pad of the mop plate 10. A water guide plate is disposed at a bottom end of the auxiliary scraper 32 to direct dirty water into the dirty water chamber 102 located below the mop bucket main body 1.

The brush strip 3 enable deep scraping and cleaning of the cleaning pad of the mop plate 10, effectively removing embedded dirt and impurities. By adding the auxiliary scraper 32 parallel to a lower part of the brush strip 3, the auxiliary scraper 32 performs partial dewatering on the cleaning pad, removing dirty water and allowing the pad to reabsorb clean water during the next spray cycle, thereby improving cleaning efficiency.

In an embodiment, as shown in FIGS. 3 to 6, a number of the limiting rollers 6 is two, the two limiting rollers 6 are symmetrically disposed on two sides of an end of the cleaning opening 103, and a number of the transmission assemblies and a number of the water pumps 7 are two.

By providing two sets of the transmission assemblies and two sets of the water pumps 7, on one hand, the water flow rate is increased, ensuring sufficient water supply for cleaning; on the other hand, the mop plate 10 receives even force on both sides of its back surface, preventing tilting and enabling smooth vertical reciprocating motion without scraping against the bucket wall.

In an embodiment, as shown in FIGS. 3, 5, 6 and 8, the limiting rollers 6 are rubber wheels, or an outer wheel surface of each of the limiting rollers 6 is sleeved with a rubber gasket, and friction strips 1001 are disposed on contact positions between the back of the mop plate 10 and the limiting rollers 6, respectively.

Specifically, the friction strips 1001 may be formed as embossed knurled patterns or as adhered sandpaper friction strips.

By using rubber wheels for the limiting rollers 6 or an outer wheel surface of each of the limiting rollers 6 is sleeved with a rubber gasket, the friction between the limiting rollers 6 and the back surface of the mop plate 10 is increased, thereby ensuring smooth driving of the limiting rollers 6. By providing corresponding friction strips 1001 on the back surface of the mop plate 10, the friction with the limiting rollers 6 is further enhanced, preventing slippage of the limiting rollers 6.

A working principle of the mop bucket pump water cleaning mechanism is as follows.

When a mop needs to be cleaned, the mop plate 10 is raised and inserted into the cleaning opening 103, with a mop handle facing the small end of the port. The friction strips 1001 on the back of the mop plate 10 come into contact with the limiting rollers 6, respectively. During the up-and-down insertion and withdrawal of the mop plate 10, the two friction strips 1001 drive their limiting rollers 6 to rotate, respectively. The limiting rollers 6 then drive the rocker arms 9 to rotate, and the eccentric shaft heads 901 push and pull the top ends of the connecting rods 8. The bottom ends of the connecting rods 8 push and pull the pistons 71 of the water pumps 7, driving the pistons 71 to perform a reciprocating linear motion to achieve the water pumping action. The water pumps 7 draw clean water from the clean water chamber 101 and direct it along the outlet pipes 701 and water-guiding channels 401 to the cleaning assembly. Simultaneously, after the clean water storage trough 41 is filled, water is sprayed through the water outlets 501 at the front end of the clean water cover plate 5 onto the cleaning pad as it moves up and down, rinsing the pad. The brush strip 3 is configured to perform deep scraping and cleaning of the cleaning pad of the mop plate 10, removing embedded dirt and impurities. The auxiliary scraper 32 is configured to perform semi-dry dewatering on the cleaning pad, removing dirty water and allowing the pad to reabsorb clean water during the next spray cycle, thereby improving cleaning efficiency.

In summary, the mop bucket pump water cleaning mechanism of the disclosure uses the limiting rollers 6 as the driving power source for the water pumps 7, achieving secondary utilization of power while providing rolling limitation for the mop plate 10. Compared with the related art, this avoids the need for additional gear assemblies, simplifies the structure, and reduces the failure rate of the tool. In addition, by coaxially and fixedly connecting the central axis of the rocker arm 9 with that of the limiting roller 6, the transmission structure is simplified, and the rotation of the central axis is directly converted into the reciprocating linear motion of the piston 71, thereby improving kinetic energy efficiency. The split half-shaft design at the cantilever end of the eccentric shaft head 901 also facilitates the disassembly and installation of the connecting rod 8. Through an arrangement of the water-guiding channel 401 and the clean water storage trough 41, the water discharged from the water pumps 7 can be smoothly conveyed. The clean water cover plate 5 seals the clean water storage trough 41 and forms water outlets 501 along its front edge to spray water onto the cleaning pad for rinsing. The use of transparent plastic material for the clean water cover plate 5 allows for a clear visual observation of the water flow. The brush strip 3 enables deep scraping and cleaning of the cleaning pad on the mop plate 10, effectively removing embedded dirt and impurities. By adding the auxiliary scraper 32 parallel to the lower part of the brush strips 3, the auxiliary scraper 32 is configured to perform partial dewatering (i.e., semi-dry dewatering) on the cleaning pad, removing dirty water and allowing the pad to reabsorb clean water during the next spray cycle, thereby improving cleaning efficiency. By providing two sets of the transmission assemblies and water pumps 7, on one hand, the water flow rate is increased, ensuring sufficient water supply for cleaning; on the other hand, the mop plate 10 receives even force on both sides of its back surface, preventing tilting and enabling smooth vertical reciprocating motion without scraping against the bucket wall. By using rubber wheels for the limiting rollers 6 or an outer wheel surface of each of the limiting rollers 6 is sleeved with a rubber gasket, the friction between the limiting rollers 6 and the back surface of the mop plate 10 is increased, thereby ensuring smooth driving of the limiting rollers 6. By providing corresponding friction strips 1001 on the back surface of the mop plate 10, the friction with the limiting rollers 6 is further enhanced, preventing slippage of the limiting rollers 6.

In an embodiment, a working method of the mop bucket pump water cleaning mechanism, which uses the mop bucket pump water cleaning mechanism mentioned above to perform cleaning operations on the mop cleaning pad. The limiting rollers are used as a power source to output power to the water pumps, which pumps water to spray and clean the cleaning pad of the mop plate.

Specifically, by utilizing a friction wheel transmission method to provide driving force for the water pumps, there is no need to additionally install racks and gears. This simplifies the structure, avoids gear jamming failures, and also shortens the transmission chain, thereby reducing resistance during cleaning.

In addition, the mop bucket of the disclosure is a clean and dirty water separation mop bucket, where the cleaning chamber and the drying chamber are separated. The cleaning opening component and the wringing opening component are arranged centrally at the two ends of the top panel, which is consistent with traditional soaking-type mop buckets. While upgrading to a clean and dirty water separation bucket, it follows operating habits of users and has been well received by consumers. By centrally arranging the clean water chamber to separate the cleaning chamber and the drying chamber, mutual interference between the two is avoided, and it also facilitates the nearby installation of the water pumps for pumping water. By providing an adapter bucket body that can be inserted between the upper bucket body and the lower bucket body, coarse filtration of the dirty water entering the dirty water chamber is achieved, preventing large or elongated debris from entering the dirty water chamber. This facilitates classified treatment and avoids clogging.

The above embodiments are only a description of the specific embodiments of the disclosure and do not limit the scope of the disclosure. Without departing from the design spirit of the disclosure, various modifications and improvements made by those skilled in the art to the technical solution of the disclosure should fall within the scope of protection determined by the claims of the disclosure.

What is claimed is:

1. A mop bucket pump water cleaning mechanism, disposed in a cleaning opening (103) of a mop bucket main body (1), wherein the mop bucket pump water cleaning mechanism comprises:
a cleaning opening bracket (2), configured to install limiting rollers (6) and a cleaning assembly, wherein the cleaning opening bracket (2) is detachably installed below a top panel (4) at a top opening of the mop bucket main body (1), and the cleaning opening (103) is defined on the top panel (4) and the cleaning opening bracket (2); and the limiting rollers (6) are configured to limit a back of a mop plate (10) inserted into the cleaning opening (103), and the cleaning assembly is configured to spray water to clean a cleaning pad on a front side of the mop plate (10); and
water pumps (7), disposed in a clean water chamber (101) of the mop bucket main body (1), wherein the limiting rollers (6) are configured to transmit power to the water pumps (7) through transmission assemblies, respectively, and the water pumps (7) are configured to pump water to the cleaning assembly.

2. The mop bucket pump water cleaning mechanism as claimed in claim 1, wherein each of the transmission assemblies comprises a connecting rod (8) and a rocker arm (9), and a central axis of the rocker arm (9) is coaxially fixedly connected to a central axis of a corresponding one of the limiting rollers (6); and an eccentric shaft head (901) of the rocker arm (9) is rotatably connected to a top end of the connecting rod (8), and a bottom end of the connecting rod (8) is connected to a piston (71) of a corresponding one of the water pumps (7).

3. The mop bucket pump water cleaning mechanism as claimed in claim 2, wherein an outlet pipe (701) of each of the water pumps (7) extends upward and is connected to a water-guiding channel (401) of the top panel (4), and the water-guiding channel (401) is configured to guide water to the cleaning assembly.

4. The mop bucket pump water cleaning mechanism as claimed in claim 3, wherein the cleaning assembly comprises a clean water cover plate (5), the top panel (4) defines a clean water storage trough (41) on an opposite side of the limiting rollers (6), an outlet end of the water-guiding channel (401) is connected to the clean water storage trough (41), the clean water cover plate (5) is sealed and covered on the clean water storage trough (41), and a front end of the clean water cover plate (5) facing towards the cleaning opening (103) defines a plurality of water outlets (501).

5. The mop bucket pump water cleaning mechanism as claimed in claim 4, wherein the clean water cover plate (5) is made of transparent plastic material.

6. The mop bucket pump water cleaning mechanism as claimed in claim 4, wherein the cleaning assembly further comprises a brush strip (3), the brush strip (3) is disposed below the clean water storage trough (41), and bristles (31) of the brush strip (3) are configured to clean the cleaning pad of the mop plate (10).

7. The mop bucket pump water cleaning mechanism as claimed in claim 6, wherein the cleaning assembly further comprises an auxiliary scraper (32), the auxiliary scraper (32) is disposed parallel to a lower part of the brush strip (3), and the auxiliary scraper (32) is configured to perform partial dewatering on the cleaning pad of the mop plate (10).

8. The mop bucket pump water cleaning mechanism as claimed in claim 1, wherein a number of the limiting rollers (6) is two, the two limiting rollers (6) are symmetrically disposed on two sides of the cleaning opening (103), and a number of the transmission assemblies and a number of the water pumps (7) are two.

9. The mop bucket pump water cleaning mechanism as claimed in claim 1, wherein the limiting rollers (6) are rubber wheels, or an outer wheel surface of each of the limiting rollers (6) is sleeved with a rubber gasket, and friction strips (1001) are disposed on contact positions between the back of the mop plate (10) and the limiting rollers (6), respectively.

10. A working method of the mop bucket pump water cleaning mechanism as claimed in claim 1, comprising
using the mop bucket pump water cleaning mechanism to clean the cleaning pad of the mop plate, comprising:
using the limiting rollers on the cleaning opening as a power source to output the power to the water pumps, to thereby pump the water to spray and clean the cleaning pad of the mop plate.
